(19) United States
(12) Patent Application Publication
(10) Pub. No.: US 2015/0040058 A1
(43) Pub. Date: Feb. 5, 2015

(54) Method and System for Inputting Variant Character and Storage Medium

(71) Applicants: Peking University Founder Group Co., Ltd., Beijing (CN); Beijing Founder Electronics Co., Ltd., Beijing (CN); Founder Information Industry Group, Beijing (CN)

(72) Inventors: Guorong Zhang, Beijing (CN); Yuxin Wang, Beijing (CN)

(73) Assignees: Peking University Founder Group Co., Ltd., Beijing (CN); Beijing Founder Electronics Co., Ltd., Beijing (CN); Founder Information Industry Group, Beijing (CN)

(21) Appl. No.: 14/095,320

(22) Filed: Dec. 3, 2013

(30) Foreign Application Priority Data
Jul. 31, 2013 (CN) 201310329860.5

(51) Int. Cl. G06F 3/023; G06F 3/01; G06F 17/24; G06F 3/0484

(52) U.S. Cl. CPC G06F 3/0236; G06F 3/04842; G06F 3/018; G06F 17/24
USPC 715/780

(57) ABSTRACT

Methods, systems, and storage medium for inputting a variant character are disclosed. Methods can include: obtaining keystroke information of a user; creating a character input code according to the keystroke information; matching the character input code with an input code in a primary code table, obtaining location information of a variant character corresponding to a basic character which is currently inputted in a secondary code table; the primary code table comprising: a code of the basic character; obtaining a variant sequence of the variant character corresponding to the basic character which is currently inputted from the secondary code table according to the location information; displaying the variant characters in a candidate window by using the variant sequence of the variant character, so that the user selects for outputting.

### CROSS-REFERENCE TO RELATED APPLICATIONS

The present application claims priority to Chinese Patent Application No. 201310329860.5 filed before the Chinese Patent Office on Jul. 31, 2013 and entitled “Method and System for Inputting Variant Character and Storage Medium”, which is incorporated herein by reference in its entirety.

### TECHNICAL FIELD

The subject matter of this specification relates to the computer information processing technical field, methods and systems for inputting a variant character, and a storage medium storing a computer program for implementing the methods for inputting a variant character.

### BACKGROUND

Currently, many languages have variant characters, such as variant Chinese characters, Mongolian deformed presentation characters, and Uyghur deformed presentation characters, and so on. A variant character, as compared with a basic character, is another form of the basic character used under different conditions. Its pronunciation is the same as the basic character, while its glyph is different from the basic character; there might be one or more variant characters for one basic character, which is decided by itself and its application.

Inputting and displaying are the basic processing of characters, currently, many linguists and relevant persons need to edit and use these basic characters and their variant characters. However, these basic characters and their variant characters are mainly used based on combination of basic characters and variant controlling characters (variation selectors and controlling characters for controlling the deformation of the variant characters). That is, not only a key corresponding to an input code of the basic character, but also a key corresponding to an input code of the variant controlling character is clicked, so that the corresponding variant character is outputted and displayed. With respect to the basic character that has a plurality of variant characters, it also has a plurality of variant controlling characters. For some of the variant characters, one variant character relates to a plurality of variant controlling characters, which requires the user to remember the variant controlling characters corresponding to each variant character and the arrangement order thereof.

### SUMMARY

Innovative aspects of the present invention provide methods and systems for inputting a variant character and a storage medium, so as to facilitate a user to input a variant character.

For this purpose, the disclosed subject matter provides the following technical solutions: A method for inputting a variant character, including:

obtaining keystroke information of a user;

creating a character input code according to the keystroke information;

matching the character input code with an input code in a primary code table, obtaining location information of a variant character corresponding to a basic character which is currently inputted in a secondary code table; the primary code table comprising: a code of the basic character, the input code corresponding to the basic character, location information of the variant character corresponding to the basic character in the secondary code table;

obtaining a variant sequence of the variant character corresponding to the basic character which is currently inputted from the secondary code table according to the location information, the secondary code table comprising: a serial number of the variant character and the variant sequence of the variant character;

displaying the variant characters in a candidate window by using the variant sequence of the variant character, so that the user selects for outputting.

The input code can be pronunciation of the basic character.

The method can include:

Creating the primary code table and the secondary code table respectively according to statistic information.

The statistic information can include: the variant character corresponding to the basic character, the code of the basic character and the input code of the basic character, codes of a variation selector and a controlling character of the variant character.

The method can include:

Displaying a key corresponding to each variant character in the variant sequence, while displaying the variant sequence of the variant character;

While perceiving an operation that the user clicked the key, outputting and displaying the variant character corresponding to the key.

A system for inputting a variant character, can include:

An information acquisition unit, configured to obtain keystroke information of a user;

An input code creating unit, configured to create a character input code according to the keystroke information;

a first inquiring unit, configured to match the character input code with an input code in a primary code table, obtain location information of a variant character corresponding to a basic character which is currently inputted in a secondary code table; the primary code table comprising: a code of the basic character, the input code corresponding to the basic character, location information of the variant character corresponding to the basic character in the secondary code table;

a second inquiring unit, configured to obtain a variant sequence of the presentation form characters corresponding to the basic character which is currently inputted from the secondary code table according to the location information, the secondary code table comprising: a serial number of the variant character and the variant sequence of the variant character;

a candidate unit, configured to displaying the variant characters in a candidate window by using the variant sequence of the variant character, so that the user selects for outputting.

The input code can include pronunciation of the basic character.

The system can include:

A code table creating unit, configured to create the primary code table and the secondary code table respectively according to statistic information.

The statistic information can include:

The variant character corresponding to the basic character, the code of the basic character and the input code of the basic character, codes of a variation selector and a controlling character code of the variant character.

The candidate unit can be configured to display a corresponding key for each variant character in the variant sequence when the variant sequence of the variant character is displayed;

The system can include:

An output unit, configured to output and display the variant character corresponding to the key while an operation that the user clicked the key is perceived.

A storage medium, storing a computer program for implementing the above method for inputting a variant character.

Innovative aspects of the present invention provide methods and systems for inputting a variant character, so that a user inputs a variant character in the same way as inputting a basic character, thus, while inputting a variant character intuitively and efficiently, the problem that it is difficult for a user to remember the variant sequence is solved. This method is intuitive, concise and easy to use. Therefore it is possible to input and edit the variant characters more efficiently and accurately.

### BRIEF DESCRIPTION OF THE DRAWINGS

In order to describe the disclosed subject matter more clearly, the appended drawings are briefly described. It is obvious that the drawings described below are only used for illustrate some of the features of the subject matter, for a person skilled in the art, other drawings and features may be obtained based on these drawings and the following description.

FIG. 1 is a flow chart showing an example method for inputting a variant character according;

FIG. 2 is a schematic structural diagram showing an example system for inputting a variant character;

FIG. 3 is a schematic structural diagram showing an example system for inputting a variant character.

### DETAILED DESCRIPTION

With respect to inputting a variant character by combining its corresponding basic character and variant controlling character requires a user to remember the variant controlling characters corresponding to each variant character and the arrangement order thereof, implementations described in this specification include a method and a system for inputting a variant character and a storage medium, so that it is not necessary for a user to remember the rules for varying a basic character to a variant character. The user only needs to input the basic character, and the system will automatically display the sequence of variant characters corresponding to the basic character, so that the user may input a variant character in an intuitive and convenient way, which will greatly facilitate the user to input a variant character.

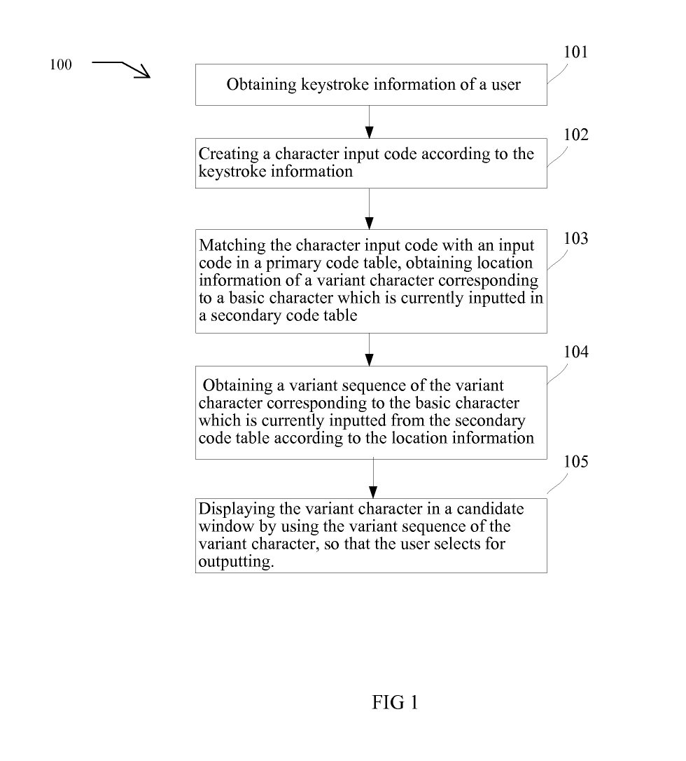

FIG. 1 is a flow chart showing an example method 100 for inputting a variant character, the method 100 can include the following steps:

Step 101 includes obtaining keystroke information of a user.

The keystroke information refers to information generated by clicking a key in a keyboard by a user. With respect to different input methods and character codes, when inputting one character, different keys might need to be clicked, these keys correspond to a input code of the character.

Step 102 includes creating a character input code according to the keystroke information.

Step 103 includes matching the character input code with an input code in a primary code table, obtaining location information of a variant character corresponding to a basic character which is currently inputted in a secondary code table; the primary code table comprising: a code of the basic character, the input code corresponding to the basic character, location information of the variant character corresponding to the basic character in the secondary code table.

Step 104 includes obtaining a variant sequence of the variant character corresponding to the basic character which is currently inputted from the secondary code table according to the location information, the secondary code table comprising: a serial number of the variant character and the variant sequence of the variant character.

Step 105 includes displaying the variant characters in a candidate window by using the variant sequence of the variant character, so that the user selects for outputting.

In practical applications, while displaying the variant sequence of the variant character, a key corresponding to each variant character in the variant sequence may be further displayed. Thus, while the operation that a user clicked the key is perceived, the variant character corresponding to the key are outputted and displayed.

Above-mentioned key could be a digital key or any other function key, without restriction.

For an input terminal with a touch screen, it may only display the variant characters, then output the corresponding variant character according to user's selection.

It should be noted that, other methods may also be adopted to make the user easily select variant characters for outputting, which will not be restricted by the examples discussed in this specification.

By using the method for inputting a variant character described herein, a user may input a variant character in the same way as inputting a basic character, and while inputting a variant character intuitively and efficiently, the problem that it is difficult for a user to remember the variant sequence is solved. This method is intuitive, concise and easy to use. Therefore it is possible to input and edit the variant character more efficiently and accurately.

It should be noted that, the above-mentioned primary code table and the secondary code table may be created in advance according to a basic character and its corresponding variant character(s).

In some implementations, the primary code table includes three parts of contents, they are a code of a basic character (the basic character is a character defined in Unicode), an input code of the basic character, and information index of a variant character.

In some implementations, the secondary code table includes a serial number of a variant character and a variant sequence of the variant character.

In the following, taking Mongolian characters as an example, the procedure of creating the primary code table and the secondary code table is described.

The writing (presentation) of a Mongolian character varies according to its attributes, such as its different locations in a word, its part of speech, and so on, i.e., the variant of the character is presented to a person. Therefore, a Mongolian character may be divided into a nominal character and a presentation forms character, the nominal character refers to a most representative form in various variants of the character, and the presentation forms character refers to the variants of the character presented to a person.

The above-mentioned nominal character could be considered as the basic character of Mongolian, the presentation forms character could be considered as the variant character(s) corresponding to the basic character.

The procedure of creating the primary code table and the secondary code table is as follows:

(1) calculating basic characters whose variant characters need to be outputted, codes and input codes of the basic characters. In some implementations, pronunciation of the basic characters can be used as their input codes.

As shown in the following table 1, the codes and the input codes of the nominal characters for some Mongolian are shown.

TABLE 1

| Code of basic | Basic character | |
|---|---|---|
| character | glyph | Input code |
| 1820 | [symbol] | a |
| 1821 | [symbol] | e |

(2) calculating all variant characters corresponding to each basic character, codes of the variation selector and controlling character corresponding to each variant character, and sorting these variant characters.

As shown in the following table 2, the variant controlling characters (variation selection characters and controlling characters) of some Mongolian characters are shown.

TABLE 2
variant
controlling
character
180B
180C
180D
200D

As shown in the following table 3, Glyph of some variant characters and serial numbers of the variant characters corresponding to the basic character in the table 1 are shown.

TABLE 3

| | Glyph | Glyph of | |
|---|---|---|---|
| Code of basic | of basic | variant | Serial number of |
| character | character | character | variant character |
| 1820 | [symbol] | [symbol] | (1) |
| | | [symbol] | (2) |
| | | [symbol] | (3) |
| | | [symbol] | (4) |
| | | . . . | . . . |
| 1821 | [symbol] | [symbol] | (1) |
| | | [symbol] | (2) |
| | | [symbol] | (3) |
| | | [symbol] | (4) |
| | | . . . | . . . |

(3) creating the variant sequence of the variant character.

Specifically, the variant sequences of the variant characters obtained from the statistics can be created according to the use rule of Mongolian, the variant sequences are used to transform the basic character to the variant characters, the variant sequences are in a form of combining the basic character with the variant controlling character (the variation selector and the controlling character).

As shown in the following table 4, the variant sequences of various variant characters corresponding to the basic character 1820 of Mongolian are shown.

TABLE 4

| Serial number of the | Variant sequence of the |
|---|---|
| variant character | variant character |
| (1) | 1820 + 200D |
| (2) | 200D + 1820 + 200D |
| (3) | 200D + 1820 + 180B + 200D |
| (4) | 200D + 1820 + 180C + 200D |

(4) Creating a primary code table and a secondary code table.

Wherein, the primary code table contains several records, wherein, each record contains: a code of a basic character, an input code corresponding to the basic character, and starting location of a variant character corresponding to the basic character in the secondary code table, and its ending location can be determined by the starting location of a variant character corresponding to the next basic character in the secondary code table.

The secondary code table records serial numbers and variant sequences of variant characters corresponding to each basic character in the primary code table.

By using the above-mentioned primary code table and secondary code table, the input of variant characters may be intuitive, concise and easy, so that the user may input and edit the variant characters more efficiently and accurately.

It should be noted that, a standard interface may be adapted to output variant characters, so that this subject matter may be widely applied to current common edit software, such as Office, Photoshop, etc.

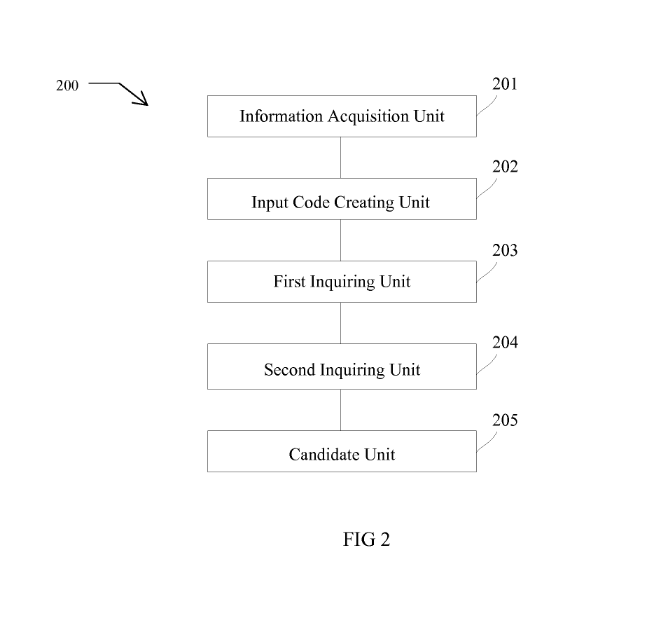

Accordingly, some implementations include a system for inputting a variant character. FIG. 2 shows a schematic structural diagram of an example system 200.

In some implementations, the system 200 includes an information acquisition unit 201, configured to obtain keystroke information of a user.

The system 200 can also include an input code creating unit 202, configured to create a character input code according to the keystroke information.

The system 200 can also include a first inquiring unit 203, configured to match the character input code with an input code in a primary code table, obtain location information of a variant character corresponding to a basic character which is currently inputted in a secondary code table; the primary code table comprising: a code of the basic character, the input code corresponding to the basic character, location information of the variant character corresponding to the basic character in the secondary code table.

The system 200 can also include a second inquiring unit 204, configured to obtain a variant sequence of the presentation form characters corresponding to the basic character which is currently inputted from the secondary code table according to the location information, the secondary code table comprising: a serial number of the variant character and the variant sequence of the variant character.

The system 200 can also include a candidate unit 205, configured to displaying the variant characters in a candidate window by using the variant sequence of the variant character, so that the user selects for outputting.

The primary code table and the secondary code table mentioned above need to be created in advance, and loaded while starting the system.

In some implementations, the system 200 for inputting a variant character can further include a code table creating unit (not shown), configured to create the primary code table and the secondary code table respectively according to statistic information.

The statistic information mentioned above comprises: the variant character corresponding to the basic character, the code of the basic character and the input code of the basic character, codes of a variation selector and a controlling character code of the variant character.

The specific procedure to create the code tables could be understood by reference to the method previously described, which will not be repeatedly described herein.

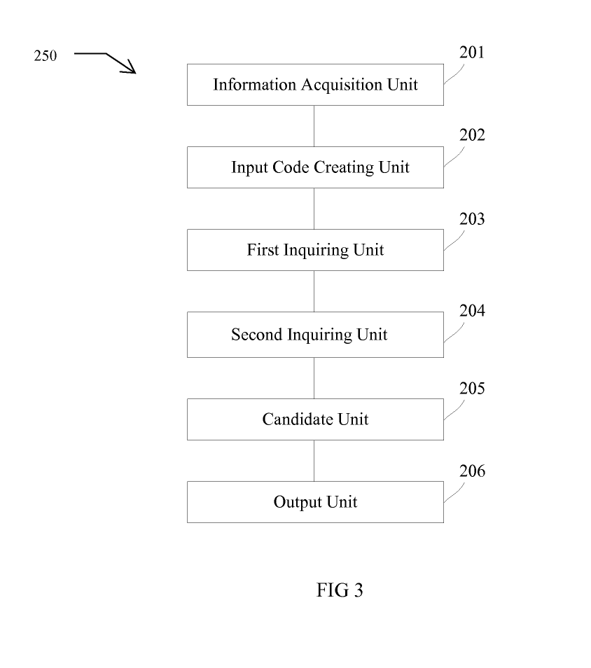

As shown in FIG. 3, it is an example schematic structural diagram showing a system 250 for inputting a variant character.

The difference between the systems in FIG. 2 and FIG. 3 is that, in FIG. 3, the system 250 further includes an output unit 206.

In this example, the candidate unit 205 further displays corresponding key(s) for each variant character in the variant sequence when the variant sequence of the variant character is displayed; accordingly, the output unit 206 is configured to output and display the variant character corresponding to the key while an operation that the user clicked the key is perceived.

By using the system for inputting a variant character, a user may input a variant character in the same way as inputting a basic character, and while inputting a variant character intuitively and efficiently, the problem that it is difficult for a user to remember the variant sequence is solved. This method is intuitive, concise and easy to use. Therefore it is possible to input and edit the variant characters more efficiently and accurately. The system for inputting a variant character could adopt a standard interface to output variant characters, such that the system may be widely applied to current common edit software, such as Office, Photoshop, and so on.

In some implementations, a storage medium is configured to store a computer program for implementing the method for inputting a variant character.

Aspects of the disclosed subject matter have been explained in a progressive way, the similar parts between the aspects should be referenced to each other, the description of each aspect focuses on the different parts from the others. The systems described above is only for illustration, wherein the units described as a separate unit may be or may not be physically separated, an element shown as a unit may be or may not be a physical unit, which means all of them may be located in one location, or may be distributed on a plurality of units over the network. A certain parts or all of the modules could be used to achieve the purpose of the solutions according to actual requirements. A person skilled in the art may understand and implement the technical solutions without creative work.

Each element discussed above could be implemented by hardware, or software modules running in one or more processors, or the combination thereof. It is should be understood by a person skilled in the art that, in practice, it is possible to utilize a microprocessor or a digital signal processor (DSP) to implement some or all of the functions of some or all of the elements described.

The description provided above is only used to assist one to understand the methods and systems of the present invention without limitation; meanwhile, for an ordinary skilled in the art, modifications can be made as well as the scope of application, therefore, the content of the description should not be understood as a restriction to the present invention in any way.

What is claimed is:

1. A method for inputting a variant character, comprising:
obtaining keystroke information of a user;
creating a character input code according to the keystroke information;
matching the character input code with an input code in a primary code table;
obtaining location information of a variant character corresponding to a basic character which is currently inputted in a secondary code table, the primary code table comprising: a code of the basic character, the input code corresponding to the basic character, location information of the variant character corresponding to the basic character in the secondary code table;
obtaining a variant sequence of the variant character corresponding to the basic character which is currently inputted from the secondary code table according to the location information, the secondary code table comprising: a serial number of the variant character and the variant sequence of the variant character; and
displaying the variant characters in a candidate window by using the variant sequence of the variant character, so that the user selects for outputting.

2. The method according to claim 1, wherein the input code is pronunciation of the basic character.

3. The method according to claim 1, further comprising:
creating the primary code table and the secondary code table respectively according to statistic information.

4. The method according to claim 3, wherein the statistic information comprises:
the variant character corresponding to the basic character, the code of the basic character and the input code of the basic character, codes of a variation selector and a controlling character of the variant character.

5. The method according to claim 1, further comprising:
displaying a corresponding key for each variant character in the variant sequence, while displaying the variant sequence of the variant character; and
while perceiving an operation that the user clicked the key, outputting and displaying the variant character corresponding to the key.

6. The method according to claim 2, further comprising:
displaying a corresponding key for each variant character in the variant sequence, while displaying the variant sequence of the variant character; and
while perceiving an operation that the user clicked the key, outputting and displaying the variant character corresponding to the key.

7. The method according to claim 3, further comprising:
displaying a corresponding key for each variant character in the variant sequence, while displaying the variant sequence of the variant character; and
while perceiving an operation that the user clicked the key, outputting and displaying the variant character corresponding to the key.

8. The method according to claim 4, further comprising:
displaying a corresponding key for each variant character in the variant sequence, while displaying the variant sequence of the variant character; and
while perceiving an operation that the user clicked the key, outputting and displaying the variant character corresponding to the key.

9. A system for inputting a variant character, comprising:
an information acquisition unit, configured to obtain keystroke information of a user;
an input code creating unit, configured to create a character input code according to the keystroke information;
a first inquiring unit, configured to match the character input code with an input code in a primary code table, obtain location information of a variant character corresponding to a basic character which is currently inputted in a secondary code table; the primary code table comprising: a code of the basic character, the input code corresponding to the basic character, location information of the variant character corresponding to the basic character in the secondary code table;
a second inquiring unit, configured to obtain a variant sequence of the presentation form characters corresponding to the basic character which is currently inputted from the secondary code table according to the location information, the secondary code table comprising: a serial number of the variant character and the variant sequence of the variant character; and
a candidate unit, configured to displaying the variant characters in a candidate window by using the variant sequence of the variant character, so that the user selects for outputting.

10. The system according to claim 9, wherein the input code is pronunciation of the basic character.

11. The system according to claim 9, further comprising:
a code table creating unit, configured to create the primary code table and the secondary code table respectively according to statistic information.

12. The system according to claim 11, wherein the statistic information comprises:
the variant character corresponding to the basic character, the code of the basic character and the input code of the basic character, codes of a variation selector and a controlling character code of the variant character.

13. The system according to claim 9, wherein,
the candidate unit is further configured to display a corresponding key for each variant character in the variant sequence when the variant sequence of the variant character is displayed;
the system further comprising:
an output unit, configured to outputting and displaying the variant character corresponding to the key while an operation that the user clicked the key is perceived.

14. The system according to claim 10, wherein,
the candidate unit is further configured to display a corresponding key for each variant character in the variant sequence when the variant sequence of the variant character is displayed;
the system further comprising:
an output unit, configured to outputting and displaying the variant character corresponding to the key while an operation that the user clicked the key is perceived.

15. The system according to claim 11, wherein,
the candidate unit is further configured to display a corresponding key for each variant character in the variant sequence when the variant sequence of the variant character is displayed;
the system further comprising:
an output unit, configured to outputting and displaying the variant character corresponding to the key while an operation that the user clicked the key is perceived.

16. The system according to claim 12, wherein,
the candidate unit is further configured to display a corresponding key for each variant character in the variant sequence when the variant sequence of the variant character is displayed;
the system further comprising:
an output unit, configured to outputting and displaying the variant character corresponding to the key while an operation that the user clicked the key is perceived.

17. A non-transitory storage medium, storing a computer program that causes one or more computers to perform operations comprising:
obtaining keystroke information of a user;
creating a character input code according to the keystroke information;
matching the character input code with an input code in a primary code table;
obtaining location information of a variant character corresponding to a basic character which is currently inputted in a secondary code table, the primary code table comprising: a code of the basic character, the input code corresponding to the basic character, location information of the variant character corresponding to the basic character in the secondary code table;
obtaining a variant sequence of the variant character corresponding to the basic character which is currently inputted from the secondary code table according to the location information, the secondary code table comprising: a serial number of the variant character and the variant sequence of the variant character; and
displaying the variant characters in a candidate window by using the variant sequence of the variant character, so that the user selects for outputting.
